(19) United States
(12) Patent Application Publication
(10) Pub. No.: US 2016/0006075 A1
(43) Pub. Date: Jan. 7, 2016

(54) POSITIVE ELECTRODE AND NONAQUEOUS ELECTROLYTE SECONDARY BATTERY

(71) Applicant: DAISO CO., LTD., Osaka (JP)

(72) Inventors: Masato TABUCHI, Osaka (JP); Katsuhito MIURA, Osaka (JP); Hajime MIYASHIRO, Osaka (JP); Yo KOBAYASHI, Osaka (JP)

(21) Appl. No.: 14/768,562

(22) PCT Filed: Feb. 26, 2014
(86) PCT No.: PCT/JP2014/054727

§ 371 Date: Aug. 18, 2015

(30) Foreign Application Priority Data
Feb. 27, 2013 (JP) 2013-036841

(51) Int. Cl. H01M 10/0565; H01M 4/36; H01M 4/04; H01M 4/1391; H01M 10/0525; H01M 4/485

(52) U.S. Cl. CPC H01M 10/0565; H01M 10/0525; H01M 4/485; H01M 4/0404; H01M 4/0409; H01M 4/0435; H01M 4/0471; H01M 4/0416; H01M 4/1391; H01M 4/366; H01M 2300/0082

(57) ABSTRACT

Disclosed is a secondary battery having high capacity and excellent charge/discharge cycle characteristics, which is obtained by employing a positive electrode that is obtained by covering the surface of a positive electrode material with a polymer solid electrolyte composition using a polyether copolymer and an electrolyte salt compound that is a combination of lithium bisoxalate borate and another lithium salt compound. With respect to the positive electrode, the polymer solid electrolyte and/or the positive electrode material contains a compound that has a phenol structure wherein both of two ortho positions are substituted by a tert-butyl group.

### TECHNICAL FIELD

The present invention relates to a positive electrode, and a nonaqueous electrolyte secondary battery which comprises a positive electrode material, a negative electrode material and a nonaqueous electrolyte. Particularly, the present invention relates to a nonaqueous electrolyte secondary battery having high capacity and excellent cycle charge/discharge characteristics, wherein the battery is obtained by using a positive electrode which comprises a compound having a phenol structure wherein both of two ortho positions are substituted with a tert-butyl group.

### BACKGROUND ART

Conventionally, in a nonaqueous electrolyte secondary battery represented by a lithium ion battery, an electrolyte is used in the form of a solution or a paste from a viewpoint of ion conductivity. However, since an instrument is possibly damaged by a liquid leakage, various safety measures are required so that the development of a large-sized battery has been obstructed.

Under these circumstances, a solid electrolyte, such as an inorganic crystalline substance, an inorganic glass and an organic polymer substance, is proposed. However, the inorganic electrolyte has high ion conductivity, but the electrolyte comprises a crystalline substance or an amorphous substance, a relaxation of volume change by the positive/negative electrode active material at the time of charge and discharge is difficult so that enlargement of the battery is difficult. On the other hand, the progress of the organic polymer substance is expected, since the organic polymer substance generally is excellent in plasticity, bending processability, moldability and design freedom degree of an applied device.

If the organic solid polymer electrolyte can be combined with the positive/negative electrode materials conventionally used for the lithium ion battery, the large-sized battery having higher safety can be developed. However, good characteristics were not reported on batteries comprising the above-mentioned positive/negative electrode material and polymer electrolyte.

For example, as previous reports on a combination of a lithium ion conductive polymer (polymer electrolyte) and a positive electrode laminar compound, Patent Document 1 reports that cycle life has been improved by protecting a positive electrode surface with an inorganic material in order to suppress the deterioration of the organic electrolyte located near the positive electrode. However, a discharge capacity after 50 cycles is decreased to be 60% of an initial capacity, and thus the cycle life is problematic.

The trial of adding a radical scavenger like an antioxidant into a positive electrode is also studied so as to inhibit the oxidative degradation of the organic electrolyte. Patent Documents 2 and 3 describe conventional phenolic antioxidants as the radical scavenger. However, it seems that the phenolic antioxidant having a hydroxyl group which has solubility into the electrolyte and has reactivity with a Li ion can hardly exhibit an inhibition effect.

### PRIOR ART DOCUMENTS

### Patent Documents

Patent Document 1: JP 2003-338321A
Patent Document 2: JP 10-162809A
Patent Document 3: JP 11-67211A

### SUMMARY OF INVENTION

### Problems to be Solved by the Invention

One of objects addressed by the present invention is to provide a secondary battery having high capacity and excellent cycle charge/discharge characteristics in view of the above-mentioned circumstances.

### Means for Solving the Problems

The inventors intensively studied to solve the above-mentioned problems, discovered that a secondary battery having high capacity and excellent cycle charge/discharge characteristics can be obtained by adopting, in a secondary battery, a positive electrode having a surface of a positive electrode material covered with a composition for solid polymer electrolyte comprising a polymer having an ethylene oxide structure (—CH₂CH₂O—) and an electrolyte salt compound, wherein one or both of the solid polymer electrolyte and the positive electrode material comprise a phenol compound having a phenolic structure in which both of two ortho-positions are substituted with a tert-butyl group, and then completed the present invention.

Generally, the covered surface is a main surface, particularly one main surface. The “main surface” as used herein means a plane contacting with a solid electrolyte. Generally, the “main surface” is a plane (surface) which has a largest area in a negative electrode material or positive electrode material.

Namely, the present invention is completed based on the above-mentioned knowledge, and provides a method of producing a nonaqueous electrolyte secondary battery having a positive electrode wherein a surface of a positive electrode material is covered with a composition for solid polymer electrolyte comprising the following components (i) and (ii), and the positive electrode material comprises a phenol compound having a phenolic structure in which both of two ortho-positions are substituted with a tert-butyl group.

Embodiments of the present invention are as follows:

[1] A positive electrode having a surface of a positive electrode material covered with a solid polymer electrolyte,
wherein the solid polymer electrolyte comprises:
(i) a polymer having an ethylene oxide structure (—CH₂CH₂O—), and
(ii) an electrolyte salt compound which is a combination of lithium bis(oxalate)borate with another lithium salt compound,

one or both of the solid polymer electrolyte and the positive electrode material comprise:

(iii) a phenol compound having a phenolic structure in which both of two ortho-positions are substituted with a tert-butyl group.
[2] The positive electrode according to [1], wherein the polymer (i) is a polyether copolymer comprising:
95-5 mol % of repeating units derived from a monomer of the formula (1):

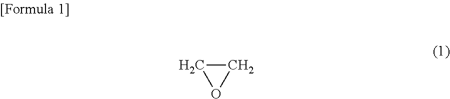

5-95 mol % of repeating units derived from a monomer of the formula (2):

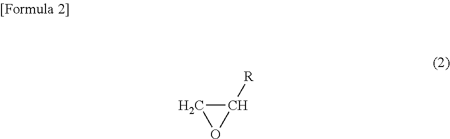

wherein R is an alkyl group having 1 to 12 carbon atoms, or —CH₂O(CR¹R²R³) where R¹, R² and R³ are a hydrogen atom or —CH₂O(CH₂CH₂O)ₙR⁴ in which n and R⁴ may be different among R¹, R² and R³, and R⁴ is an alkyl group having 1 to 12 carbon atoms or an aryl group optionally having a substituent group, and n is an integer of 0 to 12, and
0 to 20 mol % of repeating units derived from a monomer of the formula (3):

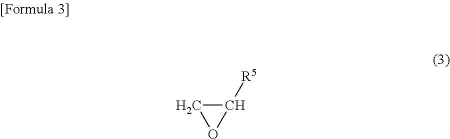

wherein R⁵ is a group containing an ethylenically unsaturated group.
[3] The positive electrode according to [1], wherein the phenol compound (iii) is incorporated into one or both of the solid polymer electrolyte and the positive electrode material;
by a method of coating, on a surface of the positive electrode material, a solution of the solid polymer electrolyte containing the phenol compound, or by a method of coating, on a metal electrode substrate, a slurry of the positive electrode material containing the phenol compound.
[4] The positive electrode according to any one of [1] to [3], wherein the phenol compound (iii) is a compound of the general formula:

A(X)₃

wherein A is a phenol group having tert-butyl groups positioned at two ortho-positions to OH group in the phenol group,
each of X is, the same or different, a hydrogen atom; a hydrocarbon group having 1 to 30 carbon atoms which may be interrupted by a sulfur atom, a nitrogen atom, an ester group, an amide group or a phosphate group is a group; or a group having the A group.
[5] The positive electrode according to any one of [1] to [4], wherein the phenol compound (iii) is at least one selected from the group consisting of 2,6-di-tert-butyl-phenol, 2,6-di-tert-butyl-4-methylphenol, 2,6-di-tert-butyl-4-ethylphenol, 1,6-hexanediol-bis[3-(3,5-di-tert-butyl-4-hydroxyphenyl) propionate], 2,4-bis-(n-octylthio)-6-(4-hydroxy-3,5-di-tert-butylanilino)-1,3,5-triazine, tetrakis[methylene-3-(3,5-di-tert-butyl-4-hydroxyphenyl) propionate]methane, 2,2-thio-diethylene bis[3-(3,5-di-tert-butyl-4-hydroxyphenyl) propionate], octadecyl-3-(3,5-di-tert-butyl-4-hydroxyphenyl) propionate, N,N′-hexamethylene bis(3,5-di-tert-butyl-4-hydroxy-hydrocinnamamide), 3,5-di-tert-butyl-4-hydroxybenzyl phosphonate-diethyl ester, 1,3,5-trimethyl-2,4,6-tris(3,5-di-tert-butyl-4-hydroxybenzyl)benzene, tris(3,5-di-tert-butyl-4-hydroxybenzyl) isocyanurate, and isooctyl-3-(3,5-di-tert-butyl-4-hydroxyphenyl) propionate.
[6] The positive electrode according to any one of [1] to [5], wherein an aprotic organic solvent is further added to the solid polymer electrolyte.
[7] The positive electrode according to [6], wherein the aprotic organic solvent is selected from the group consisting of ethers and esters.
[8] The positive electrode according to any one of [1] to [7], wherein the positive electrode is heat-treated before an electrical potential is applied.
[9] The positive electrode according to [8], wherein the heat treatment is conducted within the range of at least 50° C. and at most 150° C.
[10] The positive electrode according to any one of [1] to [9], wherein the positive electrode material has any of compositions of:

AMO₂

wherein A is an alkali metal, and
M is one or at least two transition metals which may partially contain a non-transition metal,

AM₂O₄

wherein A is an alkali metal, and
M is one or at least two transition metals which may partially contain a non-transition metal,

A₂MO₃

wherein A is an alkali metal, and
M is one or at least two transition metals which may partially contain a non-transition metal, and

AMBO₄

wherein A is an alkali metal,
B is P, Si or a mixture thereof,
M is one or at least two transition metals which may partially contain a non-transition metal.
[11] A non-aqueous electrolyte secondary battery comprising the positive electrode according to any one of [1] to [10].
[12] A method of producing the positive electrode according to any one of [1] to [10], wherein the method comprises the step of incorporating the phenol compound (iii) into one or both of the solid polymer electrolyte and the positive electrode material;
by applying, onto a surface of the positive electrode material, a solution of the solid polymer electrolyte containing the phenol compound, or
by applying, onto a metal electrode substrate, a slurry of the positive electrode material containing the phenol compound.

### Effects of the Invention

According to the present invention, a nonaqueous electrolyte secondary battery having a high capacity and being excellent in cycle charge/discharge characteristics can be provided. Particularly, the nonaqueous electrolyte secondary battery is excellent in long-term cycle life and cycle charge/discharge characteristics at an ordinary temperature (for example, 30° C.).

Hereinafter, embodiments of the present invention are explained in detail.

### MODES OF CARRYING OUT THE INVENTION

In the present invention, a surface (particularly, one main surface) of the positive electrode material is covered with the solid polymer electrolyte. The surface of the positive electrode material means a main surface (particularly, one main surface) of the positive electrode material, and micropores surface in the main surface of the positive electrode material. The solid polymer electrolyte exists on the main surface of the positive electrode material. Micropores may not exist in the main surface of the positive electrode material. The micropores in the main surface of the positive electrode material may be or may not be filled with the solid polymer electrolyte. When the micropores in the positive electrode material are filled with the solid polymer electrolyte, the positive electrode is formed from the positive electrode, and the solid polymer electrolyte filling the micropores in positive electrode material.

The phenol compound (iii) may be contained in the solid polymer electrolyte, and/or may be contained in the positive electrode material.

The polymer (i) having an ethylene oxide structure (—CH₂CH₂O—) is a polymer which has an ethylene oxide structure (—CH₂CH₂O—) in a main chain and/or a side chain. The polymer (i) preferably has the ethylene oxide structure (—CH₂CH₂O—) in the main chain. The polymer (i) may have a substituent group containing an atom other than a carbon atom and an oxygen atom, for example, a boron atom, a chlorine atom, and a nitrogen atom. Examples of the polymer (i) having an ethylene oxide structure in a main chain include:

a polymer which has an ethylene oxide structure in a main chain (particularly, a polyether polymer),

a polymer containing an boric acid ester having an ethylene oxide structure,

a (meth)acrylate polymer which has an ethylene oxide structure in a side chain (for example, copolymer between a (meth)acrylate and styrene), and

a triazine-containing polymer having an ethylene oxide structure.

Preferable is a polyether polymer which has an ethylene oxide structure in a main chain and/or a side chain, particularly in a main chain. The polymer (i) having an ethylene oxide structure (—CH₂CH₂O—) may be or may not be crosslinked.

The polyether polymer having an ethylene oxide structure in a main chain may be a polyether copolymer comprising:

95-5 mol % of repeating units derived from a monomer of the formula (1):

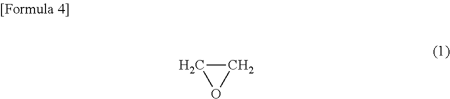

5-95 mol % of repeating units derived from a monomer of the formula (2):

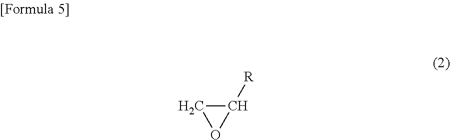

wherein R is an alkyl group having 1 to 12 carbon atoms, or —CH₂O(CR¹R²R³) where R¹, R² and R³ are a hydrogen atom or —CH₂O(CH₂CH₂O)ₙR⁴ in which n and R⁴ may be different among R¹, R² and R³, and R⁴ is an alkyl group having 1 to 12 carbon atoms or an aryl group optionally having a substituent group, and n is an integer of 0 to 12, and
0 to 20 mol % of repeating units derived from a monomer of the formula (3):

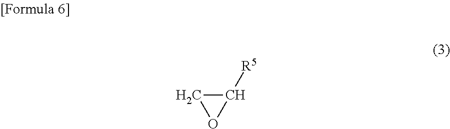

wherein R⁵ is a group containing an ethylenically unsaturated group.

The compound of formula (1) is a basic chemical product, and commercial products thereof are easily available.

The compound of formula (2) can be obtained from commercial products, or can be easily synthesized, for example, by a general ether synthetic process using an epihalohydrin and an alcohol. Examples of compounds which are commercially available products include propylene oxide, butylene oxide, methyl glycidyl ether, ethyl glycidyl ether, butyl glycidyl ether, tert-butyl glycidyl ether, benzyl glycidyl ether, 1,2-epoxydodecane, 1,2-epoxyoctane, 1,2-epoxy heptane, 2-ethylhexyl glycidyl ether, 1,2-epoxy decane, 1,2-epoxy hexane, glycidyl phenyl ether, 1,2-epoxy pentane and glycidyl isopropyl ether. Among these commercial products, preferable are propylene oxide, butylene oxide, methyl glycidyl ether, ethyl glycidyl ether, butyl glycidyl ether and glycidyl isopropyl ether. Propylene oxide, butylene oxide, methyl glycidyl ether and ethyl glycidyl ether are particularly preferable. In the monomer of formula (1) obtained by synthesis, R is preferably —CH₂O(CR¹R²R³), and at least one of R¹, R² and R³ is preferably —CH₂O(CH₂CH₂O)ₙR⁴. R⁴ is preferably an alkyl group having 1-6 carbon atoms, more preferably 1-4 carbon atoms. n is preferably 2 to 6, more preferably 2 to 4.

The compound of formula (3) can be obtained from commercial products, or can be easily synthesized, for example, by a general ether synthetic process using an epihalohydrin and an alcohol. Examples thereof include allyl glycidyl ether, 4-vinylcyclohexyl glycidyl ether, alpha-terpinyl glycidyl ether, cyclohexenyl methyl glycidyl ether, p-vinylbenzyl glycidyl ether, allyl phenyl glycidyl ether, vinyl glycidyl ether, 3,4-epoxy-1-butene, 3,4-epoxy-1-pentene, 4,5-epoxy-2-pentene, 1,2-epoxy-5,9-cyclododecadiene, 3,4-epoxy-1-vinylcyclohexene, 1,2-epoxy-5-cyclooctene, glycidyl acrylate, glycidyl methacrylate, glycidyl sorbate, glycidyl cinnamate, glycidyl crotonate and glycidyl 4-hexenoate. Among them, allyl glycidyl ether, vinyl glycidyl ether, glycidyl acrylate and glycidyl methacrylate are preferable.

The polyether polymer having an ethylene oxide structure (—CH₂CH₂O—) in a main chain comprises:

(A): repeating units derived from the monomer of the formula (1),
(B): repeating units derived from the monomer of the formula (2) and
(C): repeating units derived from the monomer of the formula (3)

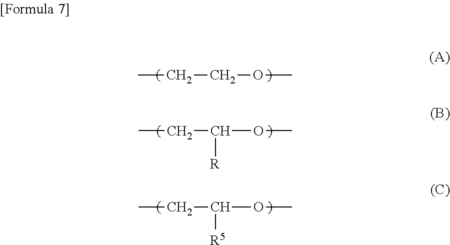

wherein R is an alkyl group having 1-12 carbon atoms, or —CH₂O(CR¹R²R³) where R¹, R² and R³ are a hydrogen atom or —CH₂O(CH₂CH₂O)ₙR⁴, in which n and R⁴ may be different among R¹, R² and R³, and R⁴ is an alkyl group having 1-12 carbon atoms and n is an integer of 0 to 12; and
R⁵ is a group containing an ethylenically unsaturated group.

R is preferably —CH₂O(CR¹R²R³), and at least one of R¹, and R² and R³ is preferably —CH₂O(CH₂CH₂O)ₙR⁴. R⁴ is preferably an alkyl group having 1-6 carbon atoms, more preferably 1-4 carbon atoms. n is preferably 2 to 6, more preferably 2 to 4.

Synthesis of the polyether polymer having an ethylene oxide structure (—CH₂CH₂O—) in a main chain can be performed as follows. The polyether copolymer is obtained by using, as a ring-opening polymerization catalyst, coordination anion initiators, such as a catalyst based on an organic aluminum, a catalyst based on an organic zinc, and an organic tin-phosphoric acid ester condensate catalyst, or anion initiators, such as potassium alkoxide, diphenylmethylpotassium and potassium hydroxide containing K⁺ as a counter ion, and reacting each of monomers at a reaction temperature of 10-120° C. in the presence or absence of a solvent with stirring. In view of, for example, a degree of polymerization or properties of an obtained copolymer, preferable is the coordination anion initiator. The organic tin-phosphoric acid ester condensate catalyst is particularly preferable, since this is easily handled.

In the polyether polymer having an ethylene oxide structure (—CH₂CH₂O—) in a main chain, a molar ratio of the repeating units (A), (B) and (C) is suitably (A) 95-5 mol %, (B) 5-95 mol % and (C) 0-20 mol %, preferably (A) 95-10 mol %, (B) 5-90 mol % and (C) 0-15 mol %, more preferably (A) 90-20 mol %, (B) 10-80 mol % and (C) 0-15 mol %. When the repeating unit (A) exceeds 95 mol %, a glass transition temperature is increased and a crystallization of an oxyethylene chain is caused so that an ion conductivity of the solid electrolyte is remarkably deteriorated. Although it is known that the ion conductivity will be generally improved by reducing the crystallinity of polyethylene oxide, the polyether copolymer of the present invention is markedly excellent in this point.

A molecular weight of the polyether polymer having an ethylene oxide structure (—CH₂CH₂O—) according to the present invention is not particularly limited, as long as good processability, mechanical strength and flexibility of the solid polymer electrolyte are obtained. In the state of non-crosslinked polymer, a weight-average molecular weight of the polymer is 10³ to 10⁷, preferably 5×10³ to 10⁷, more preferably it is 10⁴ to 10⁷.

The molecular weight in the case of the polyether polymer having an ethylene oxide structure in a main chain is not particularly limited, and the weight-average molecular weight of the polymer is usually 10³ to 10⁷, preferably 5×10³ to 10⁷, more preferably it is 10⁴ to 10⁷. Remarkably, workability is bad and handling is difficult, in the copolymer having the weight-average molecular weight larger than 10⁷.

The polyether polymer having an ethylene oxide structure in a main chain may have any of copolymerization types of a block copolymer and a random copolymer. Since the random copolymer has a larger effect of reducing a crystallinity of polyethylene oxide, the random copolymer is preferable.

In order to suppress a short circuit between electrodes, a crosslinked solid polymer electrolyte is preferably positioned between electrodes. The crosslinked solid polymer electrolyte can be introduced by, for example, a method of attaching, between the electrodes, the solid polymer electrolyte membrane crosslinked beforehand, and a method of crosslinking the solid polymer electrolyte after positioning the solid polymer electrolyte containing a radical polymerization initiator on a surface of a negative electrode.

The crosslinked solid polymer electrolyte according to the present invention is a crosslinked product prepared by adding an electrolyte salt compound to a composition for solid polymer electrolyte comprising a polymer having an ethylene oxide structure (—CH₂CH₂O—), and a radical polymerization initiator to form a solid polymer electrolyte, and then applying a heat or irradiating an active energy ray such as an ultraviolet radiation in the presence or absence of an aprotic organic solvent to crosslink the solid polymer electrolyte.

In the case of the crosslink by heat, the radical polymerization initiator is selected from, for example, an organic peroxide and an azo compound. The radical polymerization initiator is an organic peroxide usually used for crosslink, such as ketone peroxide, peroxy ketal, hydroperoxide, dialkyl peroxide, diacyl peroxide and peroxy ester, or an azo compound usually used for crosslink such as an azonitrile compound, an azo amide compound and an azo amidine compound. The amount of addition of a radical polymerization initiator varies depending on types of initiator, and the amount is usually within the range from 0.1 to 10% by weight, based on 100% by weight of the polymer having an ethylene oxide structure (—CH₂CH₂O—).

In the case of the crosslink by irradiation of active energy ray, used is the radical polymerization initiator such as alkyl phenones, benzophenones, acyl phosphine oxides, titanocenes, triazines, bis imidazoles and oxime esters. The amount of addition of a radical polymerization initiator varies depending on types of initiator, and the amount is usually within the range from 0.01 to 5% by weight, based on 100% by weight of the polymer having an ethylene oxide structure (—CH₂CH₂O—).

In the present invention, when crosslinking the composition for solid polymer electrolytes, a crosslinking aid may be used. The crosslinking aid is usually a polyfunctional compound (for example, a compound having at least two CH₂═CH—, CH₂═CH—CH₂— and/or CF₂═CF—).

The electrolyte salt compound (ii) used in the present invention includes the combination of lithium bis(oxalate)borate with the other lithium salt compounds. The electrolyte salt compound is easily available as commercial products.

In the electrolyte salt compound (ii) according to the present invention, as the other lithium salt compound other than lithium bis(oxalate)borate, mentioned are compounds comprising a cation of lithium, and an anion selected from a chlorine ion, a bromine ion, an iodine ion, a perchlorate ion, a thiocyanate ion, a tetrafluoro boronate ion, a nitrate ion, AsF₆⁻, PF₆⁻, B(C₂O₂)₂⁻, a stearyl sulfonate ion, an octylsulfonate ion, a dodecylbenzenesulfonate ion, a naphthalenesulfonate ion, a dodecylnaphthalenesulfonate ion, a 7,7,8,8-tetracyano-p-quinodimethane ion, X₁SO₃⁻, [(X₁SO₂)(X₂SO₂)N]⁻, [(X₁SO₂)(X₂SO₂)(X₃SO₂)C]⁻ and [(X₁SO₂)(X₂SO₂)YC]⁻. In the formulas, X₁, X₂, X₃ and Y each is an electron-donating group. Preferably, X₁, X₂ and X₃ each is independently a perfluoroalkyl group having 1-6 carbon atoms or a perfluoroaryl group, and Y is a nitro group, a nitroso group, a carbonyl group, a carboxyl group or a cyano group. X₁, X₂ and X₃ each is the same or different. The other lithium salt compound may be a compound containing a fluorine atom. The other lithium salt compound may be used alone or in a combination of at least two.

In the present invention, the use amount of the electrolyte salt compound is so that a numerical value of a molar number of an electrolyte salt compound/a numerical value of a total molar number of ether oxygen atoms of ethylene oxide structure (—CH₂CH₂O—) is preferably from 0.0001 to 5, more preferably from 0.001 to 0.5. A molar ratio of lithium bis(oxalate)borate to the other lithium salt compound may be from 0.1:99.9 to 90:10, for example, from 1:99 to 50:50.

In the present invention, an aprotic organic solvent may be added as, for example, a plasticizer. When the aprotic organic solvent is mixed in the solid polymer electrolyte, a crystallization of polymer is suppressed to decrease a glass transition temperature, and a large amount of an amorphous phase is formed even at low temperature, then the ionic conductivity will become good. The aprotic organic solvent is suitable for obtaining a battery having high performances and a small internal resistance by combining with the solid polymer electrolyte which can be used by the present invention. The solid polymer electrolyte according to the present invention may be a gel by combining with the aprotic organic solvent. Herein, the gel means a polymer which has been swelled with the solvent.

The aprotic organic solvent is preferably aprotic ethers and esters. Examples thereof include propylene carbonate, gamma-butyrolactone, butylene carbonate, vinyl carbonate, ethylene carbonate, dimethyl carbonate, ethyl methyl carbonate, diethyl carbonate, methyl monoglyme, methyl diglyme, methyl triglyme, methyl tetraglyme, ethyl monoglyme, ethyl diglyme, ethyl triglyme, ethyl methyl monoglyme, butyl diglyme, 3-methyl-2-oxazolidone, tetrahydrofuran, 2-methyltetrahydrofuran, 1,3-dioxolane, 4,4-methyl-1,3-dioxolane, methyl formate, methyl acetate and methyl propionate. Among them, propylene carbonate, gamma-butyrolactone, butylene carbonate, vinyl carbonate, ethylene carbonate, methyl triglyme, methyl tetraglyme, ethyl triglyme and ethyl methyl monoglyme are preferred. These can be used alone or in combination of at least two.

A method of mixing the electrolyte salt compound and the necessary aprotic organic solvent with the polymer having ethylene oxide structure (—CH₂CH₂O—) is not limited, and include a method of immersing the polymer having ethylene oxide structure into an solution containing the electrolyte salt compound and the necessary aprotic organic solvent for a long time to impregnate; a method of mixing mechanically the electrolyte salt compound and the necessary aprotic organic solvent with the polymer having ethylene oxide structure; a method of dissolving and mixing the polymer having ethylene oxide structure and the electrolyte salt compound in the aprotic organic solvent; and a method of once dissolving the polymer having ethylene oxide structure in another solvent and then mixing the aprotic organic solvent therewith. The other solvent in the case of the method using the other solvent may be various polar solvents, for example, tetrahydrofuran, acetone, acetonitrile, dimethylformamide, dimethyl sulfoxide, dioxane, methyl ethyl ketone, methyl isobutyl ketone, which are used alone or in combination of at least two. The other solvent can be removed before, during or after crosslinking the polymer having ethylene oxide structure.

The phenol compound (iii) having a phenol structure wherein both of two ortho positions are substituted with the tert-butyl groups, which can be used in the present invention, is preferably a compound of the general formula:

A(X)₃

wherein A is a phenol group which has a tert-butyl group at each of two ortho positions to an OH group in a phenol group,
each of X is, the same or different, a hydrogen atom; a hydrocarbon group having 1-30 carbon atoms which may be interrupted by a sulfur atom, a nitrogen atom, an ester group, an amide group or a phosphate group; or a group having the A group.

The A group is a phenol group which has trivalency.

That is, in the A group, six carbon atoms in the phenol ring are bonded to one OH group, two tert-butyl groups, and three X groups.

Each of three X groups is directly bonded to each of three carbon atoms of the phenol ring.

The group having the A group may have a hydrocarbon group having 1-30 carbon atoms, an isocyanurate ring, or a benzene ring (for example, benzyl) directly or indirectly bonded to the A group. The A group may be bonded to an isocyanurate ring, a benzene ring or an amidine ring through a hydrocarbon group (for example, an alkylene group) having 1-20 carbon atoms. The hydrocarbon group having 1-30 carbon atoms, the isocyanurate ring, or the benzene ring (for example, an amidine ring) directly or indirectly bonded to the A group may be directly or indirectly (through a hydrocarbon group (for example, an alkylene group) having 1-30 carbon atoms) to another A group (preferably 1 to 3 A groups).

In the X group and the A group, the hydrocarbon group having 1-30 carbon atoms may be interrupted by at least one (for example, one, two, or three) atom or group which is selected from the group consisting of a sulfur atom (—S—), a nitrogen atom (for example, —NH—), an ester group (—C(═O)O—), an amide group (for example, —NH—C(═O)—) and a phosphoric acid group (or phosphate group). These atoms or groups may be bonded to an end of the hydrocarbon group having 1-30 carbon atoms.

Generally, the phenol compound (iii) is commercially available as an antioxidant. Examples of phenol compound (iii) include 2,6-di-tert-butyl-phenol, 2,6-di-tert-butyl-4-methylphenol, 2,6-di-tert-butyl-4-ethylphenol, 1,6-hexandiol bis[3-(3,5-di-tert-butyl-4-hydroxyphenyl) propionate], 2,4-bis-(n-octylthio)-6-(4-hydroxy-3,5-di-tert-butylanilino)-1,3,5-triazine, tetrakis[methylene-3-(3,5-di-tert-butyl-4-hydroxyphenyl) propionate]methane, 2,2-thio-diethylene bis[3-(3,5-di-tert-butyl-4-hydroxyphenyl) propionate], octadecyl-3-(3,5-di-tert-butyl-4-hydroxyphenyl) propionate, N,N′-hexamethylene bis(3,5-di-tert-butyl-4-hydroxy-hydrocinnamide), 3,5-di-tert-butyl-4-hydroxybenzyl phosphonate diethyl ester, 1,3,5-trimethyl-2,4,6-tris(3,5-di-tert-butyl-4-hydroxybenzyl)benzene, tris(3,5-di-tert-butyl-4-hydroxybenzyl) isocyanurate and isooctyl-3-(3,5-di-tert-butyl-4-hydroxyphenyl) propionate. These can be used alone or in combination of at least two.

A method of adding the phenol compound (iii) is not particularly limited. In the viewpoint of homogeneity, preferable is the incorporation of the phenol compound into one or both of the solid polymer electrolyte and the positive electrode material by using (1) a method of applying, onto the surface of positive electrode material, a solution of the solid polymer electrolyte containing the phenol compound, or (2) a method of applying, onto a metal electrode substrate, a slurry of the positive electrode material containing the phenol compound.

The method of applying, onto the surface of positive electrode material, a solution of the solid polymer electrolyte containing the phenol compound (iii) includes a method of mixing the positive electrode active material with, for example, an electroconductive aid, a binder, and/or a thickener in a solvent to prepare a slurry form, coating the slurry on a metal electrode substrate, removing an excessive solvent to obtain the positive electrode material, and then coating, on the surface of positive electrode material, a solution of the solid polymer electrolyte which is prepared by mixing polymer (i) having ethylene oxide structure according to the present invention, the electrolyte salt compound (ii) which is the combination of lithium bis(oxalate)borate with the other lithium salt compounds, the phenol compound (iii) and an optional solvent.

The method of applying the phenol compound (iii) onto the metal electrode includes a method of mixing the positive electrode active material with an electroconductive aid, a binder, a thickener, and the phenol compound in a solvent to obtain a slurry and then coating the slurry on the metal electrode substrate, and removing an excessive solvent to produce the positive electrode material.

Preferably, the addition amount of the phenol compound (iii) is at least 0.1% by weight and at most 20% by weight, based on 100% by weight of the positive electrode material, in the case of applying the slurry of the positive electrode material containing a phenol compound onto the metal electrode substrate (namely, a collector), and is at least 0.1% by weight and at most 20% by weight, based on 100% by weight of the composition for solid polymer electrolyte, in the case of applying the solution of the composition for solid polymer electrolyte containing the phenol compound onto a positive electrode.

The amount of at least 0.1% by weight and at most 20% by weight can give good effects to obtain high battery characteristics.

The positive electrode material comprises, for example, a metal electrode substrate as an electrode material substrate, and a positive electrode active material on the metal electrode substrate, and a binder of satisfactorily exchanging ions with an electrolyte layer, and fixing an electroconductive aid and the positive electrode active material to the metal substrate. Aluminum, for example, is used for the metal electrode substrate. The metal is not limited to aluminum, and the metal may be, for example, nickel, stainless steel, gold, platinum and titanium.

Particles of positive electrode active material used in the present invention are an alkali metal-containing composite oxide powder which has any one of compositions of LiMO₂, LiM₂O₄, Li₂MO₃ and LiMBO₄. M comprises one or at least two transition metals, and may partially contain also a nontransition metal. B comprises P, Si or a mixture thereof. A particle size of positive electrode active material is preferably 50 microns or less, more preferably 20 microns or less. These active materials have an electromotive force of at least 3V (vs. Li/Li+).

Preferable examples of the positive electrode active material include lithium-containing composite oxides such as LiₓCoO₂, LiₓNiO₂, LiₓMnO₂, LiₓCrO₂, LiₓFeO₂, LiₓCoₐMn₁₋ₐO₂, LiₓCoₐNi₁₋ₐO₂, LiₓCoₐCr₁₋ₐO₂, LiₓCoₐFe₁₋ₐO₂, LiₓCoₐTi₁₋ₐO₂, LiₓMnₐNi₁₋ₐO₂, LiₓMnₐCr₁₋ₐO₂, LiₓMnₐFe₁₋ₐO₂, LiₓMnₐTi₁₋ₐO₂, LiₓNiₐCr₁₋ₐO₂, LiₓNiₐFe₁₋ₐO, LiₓCrₐFe₁₋ₐO₂, LiₓCrₐTi₁₋ₐO₂, LiₓFeₐTi₁₋ₐO₂, LiₓCo_{b}Mn_{c}Ni_{1-b-c}O₂, LiₓCr_{b}Mn_{c}Ni_{1-b-c}O₂, LiₓFe_{b}Mn_{c}Ni_{1-b-c}O₂, LiₓTi_{b}Mn_{c}Ni_{1-b-c}O₂, LiₓMn₂O₄, and LiₓMn_{d}Co_{2-d}O₄, LiₓMn_{d}Ni_{2-d}O₄, LiₓMn_{d}Cr_{2-d}O₄, LiₓMn_{d}Fe_{2-d}O₄, LiₓMn_{d}Ti_{2-d}O₄, Li_{y}MnO₃, Li_{y}MnₑCo₁₋ₑO₃, Li_{y}MnₑNi₁₋ₑO₃, Li_{y}MnₑFe₁₋ₑO₃, Li_{y}MnₑTi₁₋ₑO₃, LiₓCoPO₄, LiₓMnPO₄, LiₓNiPO₄, LiₓFePO₄, LiₓCo_{f}Mn_{1-f}PO₄, LiₓCo_{f}Ni_{1-f}PO₄, LiₓCo_{f}Fe_{1-f}PO₄, LiₓMn_{f}Ni_{1-f}PO₄, LiₓMn_{f}Fe_{1-f}PO₄, LiₓNi_{f}Fe_{1-f}PO₄, Li_{y}CoSiO₄, Li_{y}MnSiO₄, and Li_{y}NiSiO₄, Li_{y}FeSiO₄, Li_{y}Co_{g}Mn_{1-g}SiO₄, Li_{y}Co_{g}Ni_{1-g}SiO₄, Li_{y}Co_{g}Fe_{1-g}SiO₄, Li_{y}Mn_{g}Ni_{1-g}SiO₄, Li_{y}Mn_{g}Fe_{1-g}SiO₄, Li_{y}Ni_{g}Fe_{1-g}SiO₄, Li_{y}CoPₕSi₁₋ₕO₄, Li_{y}MnPₕSi₁₋ₕO₄, Li_{y}NiPₕSi₁₋ₕO₄, Li_{y}FePₕSi₁₋ₕO₄, Li_{y}Co_{g}Mn_{1-g}PₕSi₁₋ₕO₄, Li_{y}Co_{g}Fe_{1-g}PₕSi₁₋ₕO₄, Li_{y}Mn_{g}Ni_{1-g}PₕSi₁₋ₕO₄, Li_{y}Mn_{g}Fe_{1-g}PₕSi₁₋ₕO₄ and Li_{y}Ni_{g}Fe_{1-g}PₕSi₁₋ₕO₄ wherein x=0.01 to 1.2, y=0.01 to 2.2, a=0.01 to 0.99, b=0.01 to 0.98, and c=0.01-0.98, provided that b+c=0.02-0.99, d=1.49 to 1.99, e=0.01 to 0.99, f=0.01 to 0.99, g=0.01 to 0.99, and h=0.01-0.99.

Among the above-mentioned preferable positive electrode active materials, specific examples of more preferable positive electrode active material include LiₓCoO₂, LiₓNiO₂, LiₓMnO₂, LiₓCrO₂, LiₓCoₐNi₁₋ₐO₂, LiₓMnₐNi₁₋ₐO₂, LiₓCo_{b}Mn_{c}Ni_{1-b-c}O₂, LiₓMn₂O₄, Li_{y}MnO₃, Li_{y}MnₑFe₁₋ₑO₃, Li_{y}MnₑTi₁₋ₑO₃, LiₓCoPO₄, LiₓMnPO₄, LiₓNiPO₄, LiₓFePO₄ and LiₓMn_{f}Fe_{1-f}PO₄ wherein x=0.01 to 1.2, y=0.01 to 2.2, a=0.01 to 0.99, b=0.01 to 0.98, and c=0.01-0.98 provided that b+c=0.02-0.99, d=1.49 to 1.99, e=0.01 to 0.99, and f=0.01-0.99. The value of above-mentioned x and y is fluctuated by charge and discharge.

The negative electrode material comprises a metal electrode substrate as an electrode material substrate, and a negative electrode active material on the metal electrode substrate, and a binder of satisfactorily exchanging ions with an electrolyte layer, and fixing an electroconductive aid and negative electrode active material to the metal substrate. Copper, for example, is used for the metal electrode substrate. The metal is not limited to copper, and the metal may be, for example, nickel, stainless steel, gold, platinum and titanium.

The negative electrode active material used in the present invention is powder comprising a carbon material (for example, natural graphite, artificial graphite and amorphous carbon) which have a structure (a porous structure) capable of occlusion and release of an alkali metal ion such as a lithium ion; or a metal, such as lithium, an aluminum compound, a tin compound, a silicon compound capable of occlusion and release of an alkali metal ion such as a lithium ion. A particle size is preferably from 10 nm to 100 micrometers, more preferably from 20 nm to 20 micrometers. A mixed active material consisting of the metal and the carbon material may be used. The negative electrode active material having a porosity of about 70% can be used.

The positive electrode active material or the negative electrode active material is mixed with, for example, an electroconductive aid, a binder and a thickener in a solvent to form a slurry, and water or a water-soluble organic solvent can be used as the solvent. Examples of the electroconductive aid include an electrically conductive carbon, such as acetylene black, ketjenblack, a carbon fiber and graphite; an electrically conductive polymer; and a metal powder. The electrically conductive carbon is particularly preferable. These electroconductive aids are added in 20% by weight or less, preferably 15% by weight or less, based on 100% by weight of active materials. The binder may be at least one compound selected from a fluorine binder, an acrylic rubber, a modified acrylic rubber, a styrene-butadiene rubber, an acrylic polymer, and a vinyl polymer. The acrylic polymer is preferable, since high acid resistance, sufficient adhesion even in a low amount, and high flexibility of the electrode plates are obtained. The binder is added in preferably 5% by weight or less, more preferably 3% by weight or less, based on 100% by weight of the active materials. Examples of the thickener include carboxymethyl cellulose, methyl cellulose and hydroxyethyl cellulose, an alkali metal salt thereof, and polyethylene oxide. The thickener is added in preferably 3% by weight or less, more preferably 5% by weight or less, based on 100% by weight of the active materials.

The application of, for example, the positive electrode active material powder and the negative electrode active material powder to the metal electrode substrate can be conducted by, for example, a doctor blade method and a silk screen method.

For example, in the doctor blade method, the negative electrode active material powder and the positive electrode active material powder are dispersed in water, or an organic solvent such as n-methylpyrrolidone to obtain a slurry, then coating the slurry on a metal electrode substrate and equalizing the slurry into a suitable thickness by a blade having a predetermined slit width. After the active material is coated, the electrode is dried, for example in the state of an 80° C. vacuum in order to remove an excessive solvent. The electrode material is produced by press molding the dried electrode by a press apparatus.

Then, a solid polymer electrolyte is applied to a main surface of the electrode material by, for example, a doctor blade method. The solid polymer electrolyte is mixed with a solvent, such as acetonitrile, depending on a viscosity, to adjust to a suitable viscosity, then coated on the electrode material and optionally permitted to stand, and impregnating porous portions of the electrode material with the solid polymer electrolyte solution and heating the coated electrode material to dryness. The thickness of the coating layer (solid polymer electrolyte) after drying of solvent is preferably 400 micrometers or less, more preferably 200 micrometers or less.

Preferably, a positive electrode containing a phenol compound, which has a surface covered with a solid polymer electrolyte, is heat-treated. The heat treatment is preferably conducted before applying an electric potential. The method of the heat treatment is not particularly limited, and the heat-treatment is preferably conducted in the state that the solid polymer electrolyte surface is exposed to an inert gas atmosphere such as nitrogen and argon. The temperature of the heat treatment is preferably in the range from 50° C. to 150° C. In this temperature range, the heat treatment can be conducted in the state that an oxidative degradation of organic materials is not promoted, without spending a long time of heat treatment. The time of heat treatment varies depending on the temperature, and the time is usually within ten days, for example, from 1 hour to 48 hours.

The nonaqueous electrolyte secondary battery is can be set up by piling the negative-pole electrode (the negative electrode) and the positive-pole electrode (the positive electrode), any of which is coated with the solid polymer electrolyte. When the thickness or mechanical strength of the applied solid polymer electrolyte is insufficient, a crosslinked solid polymer electrolyte is preferably intervened between the two electrodes. The crosslinked solid polymer electrolyte can be introduced by a method of intervening a separately prepared crosslinked solid polymer electrolyte membrane between the electrodes, and a method of crosslinking the solid polymer electrolyte positioned on the negative electrode surface.

When the characteristics of only the positive electrode material are evaluated, the reversibility of an electrode material can be estimated by using a lithium sheet as a counter electrode. When the combination of the positive electrode material and the negative electrode material is evaluated, the lithium sheet is not used and the combination of the positive electrode material and the carbon negative electrode is used.

### EXAMPLES

The present invention is explained further in detail by illustrating the following Examples. However, the present invention is not limited to the following Examples, without departing from the gist of the present invention.

In the Examples, the following experiments were conducted to compare a reversible capacity and a cycle performance, in a nonaqueous electrolyte secondary battery comprising a negative electrode material, a nonaqueous electrolyte, and a positive electrode material.

### Synthesis Example

### Production of a Catalyst for Polyether Copolymerization

Into a three-necked flask provided with a stirrer, a thermometer and a distillation apparatus, 10 g of tributyltin chloride and 35 g of tributyl phosphate were charged, and heated for 20 minutes at 250° C. with stirring under a nitrogen gas stream to distill off a distillate, and then a solid condensate substance was obtained as a residue. This substance was used as a polymerization catalyst in the following Polymerization Examples.

A composition of the polyether copolymer in terms of monomer was determined according to ¹H NMR spectrum.

A gel permeation chromatography (GPC) was measured to determine a molecular weight of the polyether copolymer, and a weight-average molecular weight was calculated in terms of a standard polystyrene. The GPC measurement was performed at 60° C. by using RID-6A manufactured by Shimadzu Corp., Shodex KD-807, KD-806, KD-806M and KD-803 columns manufactured by Showa Denko K.K., and DMF as a solvent.

### Polymerization Example 1

Into a glass four-necked flask having an internal volume of 3 L which was internally replaced by a nitrogen gas, 1 g of the condensate substance produced in Synthesis Example of catalyst as a polymerization catalyst, 150 g of a glycidyl ether compound (a) adjusted to a water content of 10 ppm or less:

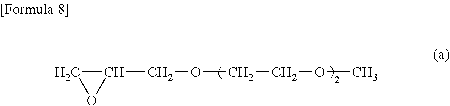

and 1000 g of n-hexane as a solvent were charged, then 150 g of ethylene oxide was added sequentially with monitoring a conversion of the compound (a) by a gas chromatography. The polymerization temperature at this time was kept at 20° C., and the polymerization reaction was conducted for 10 hours. The polymerization reaction was terminated by adding 1 mL of methanol. After removing the polymer by decantation, the polymer was dried at 45° C. under an ordinary pressure for 24 hours and then at 40° C. under a reduced pressure for 10 hours to obtain 280 g of a polymer. The weight-average molecular weight and composition in terms of monomer analysis result of the resultant polyether copolymer are shown in Table 1.

### Polymerization Example 2

Into a glass four-necked flask having an internal volume of 3 L which was internally replaced by a nitrogen gas, 1 g of the condensate produced in Synthesis Example of catalyst as a polymerization catalyst, 150 g of a glycidyl ether compound (a) adjusted to a water content of 10 ppm or less and 1000 g of n-hexane as a solvent were charged, then 150 g of ethylene oxide was added sequentially with monitoring a conversion of the compound (a) by a gas chromatography. The polymerization temperature at this time was kept at 20° C., and the polymerization reaction was conducted for 10 hours. The polymerization reaction was terminated by adding 1 mL of methanol. After removing the polymer by decantation, the polymer was dried at 45° C. under an ordinary pressure for 24 hours and then at 40° C. under a reduced pressure for 10 hours to obtain 290 g of a polymer. The analysis results of the weight-average molecular weight and the composition in terms of monomer of the resultant polyether copolymer are shown in Table 1.

TABLE 1

| Composition of a copolymer | Polymerization | Polymerization |
|---|---|---|
| (mol %) | Example 1 | Example 2 |
| Ethylene oxide | 80 | 77 |
| Compound (a) | 20 | 18 |
| Allyl glycidyl ether | | 5 |
| Weight-average molecular | 1,500,000 | 1,200,000 |
| weight of copolymer | | |

### Crosslink Example 1

1.0 g of the polyether copolymer obtained in Polymerization Example 2, 0.002 g of a photoinitiator (benzophenone), 0.05 g of a crosslinking aid (N,N′-m-phenylene-bis-maleimide), a solution of bis(trifluoromethane sulfonyl)imide lithium dissolved in 10 ml of acetonitrile, in a molar ratio: (molar number of the electrolyte salt compound)/(total molar number of ether oxygen atoms of the copolymer) of 0.05, were coated on a polyethylene terephthalate film by using a bar coater having a 500-micrometer gap, and heated at 80° C. to dryness. Then, a high-pressure mercury-vapor lamp (30 mW/cm²) was irradiated for 30 seconds in the state that a laminate film was covered on the electrolyte surface, to produce a crosslinked polymer electrolyte membrane.

### Example 1

### Production of Battery Comprising Positive Electrode Material/Solid Polymer Electrolyte/Metallic Lithium

LiCo_{1/3} Mn_{1/3} Ni_{1/3}O₂ having an average particle size of 10 micrometers was used as a positive electrode active material. To this positive electrode active material (10.0 g), added were spherical carbon particles (0.5 g) manufactured by pyrolysis of acetylene as an electroconductive aid, a styrene-butadiene rubber (SBR) (0.1 g) as a binder, and a carboxymethyl cellulose sodium salt (CMC) (0.5 g) as a thickener. After stirring them and water as a solvent for 1 hour by a stainless steel ball mill, the mixture was coated on an aluminum collector by a bar coater having a 50-micrometer gap, dried for at least 12 hours under vacuum at 80° C., and roll-pressed to give a positive electrode sheet.

The polyether copolymer (1.0 g) obtained in Polymerization Example 1, 0.05 g of 2,6-di-tert-butyl-4-methylphenol, a solution of lithium borofluoride and lithium bis(oxalate)borate (0.05 g) (molar ratio of lithium borofluoride to lithium bis(oxalate)borate was 90:10) dissolved in 10 ml of acetonitrile, in a molar ratio of (molar number of the electrolyte salt compound)/(total molar number of ether oxygen atom of the copolymer) of 0.10, were coated on the above-mentioned positive electrode sheet by a bar coater having a 500-micrometer gap and heated at 80° C., and the polymer electrolyte composition was sufficiently impregnated into the positive electrode sheet, and dried. These were heat-treated at 100° C. under an argon gas atmosphere for 12 hours to produce a positive electrode/electrolyte sheet in which the polymer electrolyte was unified on the positive electrode sheet.

In a glove box substituted with an argon gas, the crosslinked polymer electrolyte membrane obtained in Crosslink Example 1 was attached to the positive electrode/electrolyte sheet, and metallic lithium was attached as a counter electrode to assemble a 2032 type coin battery for test. Electrochemical characteristics were determined by using a charge/discharge unit manufactured by Hokuto Denko Corp., under the test condition (C/4) performing a predetermined charge/discharge in 4 hours at a constant electric current application having an upper limit of 4.2 V and a lower limit of 2.5 V, to evaluated the positive electrode. A test was conducted at an environmental temperature of 60° C. Test results are shown in Table 2.

### Example 2

### Production of Battery Comprising Positive Electrode Material/Solid Polymer Electrolyte/Metallic Lithium

A positive electrode/electrolyte sheet was produced in the same manner as in Example 1 except tetrakis[methylene-3-(3,5-di-tert-butyl-4-hydroxyphenyl) propionate]methane was used instead of 2,6-di-tert-butyl-4-methylphenol. A metallic lithium as a counter electrode was attached to this sheet to produce a coin battery. Electrochemical characteristics of the positive electrode were evaluated. Test results are shown in Table 2.

### Example 3

### Production of Battery Comprising Positive Electrode Material/Solid Polymer Electrolyte/Metallic Lithium

A positive electrode/electrolyte sheet was produced in the same manner as in Example 1 except 1,3,5-trimethyl-2,4,6-tris(3,5-di-tert-butyl-4-hydroxybenzyl) benzene was used instead of 2,6-di-tert-butyl-4-methylphenol. A metallic lithium as a counter electrode was attached to this sheet to produce a coin battery.

Electrochemical characteristics of the positive electrode were evaluated. Test results are shown in Table 2.

### Comparative Example 1

### Production of Battery Comprising Positive Electrode Material/Solid Polymer Electrolyte/Metallic Lithium

A coin battery was produced and electrochemical characteristics of the positive electrode were evaluated in the same manner as in Example 1 except that 2,6-di-tert-butyl-4-methylphenol was not added when producing the positive electrode/electrolyte sheet. Test results are shown in Table 2.

### Comparative Example 2

### Production of Battery Comprising Positive Electrode Material/Solid Polymer Electrolyte/Metallic Lithium

A positive electrode/electrolyte sheet was produced in the same manner as in Example 1 except 4,4′-butylidenebis(3-methyl-6-tert-butylphenol) was used instead of 2,6-di-tert-butyl-4-methylphenol. A metallic lithium as a counter electrode was attached to this sheet to produce a coin battery. Electrochemical characteristics of the positive electrode were evaluated. Test results are shown in Table 2.

TABLE 2

| | Ex. 1 | Ex. 2 | Ex. 3 | Com. Ex. 1 | Com. Ex. 2 |
|---|---|---|---|---|---|
| Initial | 140 | 130 | 137 | 130 | 115 |
| reversible | | | | | |
| capacity | | | | | |
| (mAh/g) | | | | | |
| Relative | 97 | 98 | 98 | 82 | Dispersion |
| capacity after | | | | | after 90 |
| 100 cycles (%) | | | | | cycles |

### Example 4

### Production of Battery Comprising Positive Electrode Material/Solid Polymer Electrolyte/Metallic Lithium

Graphite powder (porous structure material) having an average particle size of 12 micrometers was used as a negative active material. To this negative active material (10.0 g), added were carbon fiber (0.5 g) synthesized at 2000° C. or more as an electroconductive aid, SBR. (0.1 g) as a binder, and CMC (0.2 g) as a thickener. After stirring them and water as a solvent for 1 hour by a stainless steel ball mill, the mixture was coated on a cupper collector by a bar coater having a 50-micrometer gap, dried for at least 12 hours under vacuum at 80° C., and roll-pressed to give a negative electrode sheet.

The polyether copolymer (1.0 g) obtained in Polymerization Example 1, and a solution of bis(trifluoromethane sulfonyl)imide lithium dissolved in 10 ml of acetonitrile, in a molar ratio (molar number of electrolyte salt compound)/(total molar number of ether oxygen atom of the copolymer) of 0.05, were coated on the negative electrode sheet by a bar coater having a 500-micrometer gap and directly heated at 80° C. to produce a negative electrode/electrolyte sheet in which the polymer electrolyte was unified on the negative electrode sheet.

In a glove box substituted with an argon gas, the crosslinked polymer electrolyte membrane obtained in Crosslink Example 1 was attached to the positive electrode/electrolyte sheet obtained in Example 1, and the negative electrode/electrolyte sheet was attached as a counter electrode to assemble a 2032 type coin battery for an examination.

Electrochemical characteristics was determined by using a charge/discharge unit under the test condition (C/4) performing a predetermined charge/discharge in 4 hours at a constant electric current application having an upper limit of 4.2 V and a lower limit of 2.5 V, to evaluated the positive and negative electrodes. A test was conducted at an environmental temperature of 60° C. or 30° C. Test results are shown in Table 3.

### Comparative Example 3

### Production of Battery Comprising Positive Electrode Material/Solid Polymer Electrolyte/Metallic Lithium

A coin battery was produced and electrochemical characteristics of the positive and negative electrodes were evaluated in the same manner as in Example 4 except that the positive electrode/electrolyte sheet prepared in the Comparative Example 1 was used. Test results are shown in Table 3.

TABLE 3

| Test | | | |
|---|---|---|---|
| temperature | | | Com. |
| (° C.) | | Ex. 4 | Ex. 3 |
| 60 | Initial reversible capacity (mAh/g) | 128 | 123 |
| | Relative capacity after 100 cycles (%) | 95 | 82 |
| | Relative capacity after 200 cycles (%) | 91 | 68 |
| | Number of cycles at capacity maintenance | >1000 | 265 |
| | rate of 60% | | |
| 30 | Initial reversible capacity (mAh/g) | 102 | 85 |
| | Relative capacity after 100 cycles (%) | 98 | 89 |

### INDUSTRIAL APPLICABILITY

The nonaqueous electrolyte secondary battery of the present invention has high capacity, and is excellent in cycle charge/discharge characteristics. In particular, the nonaqueous electrolyte secondary battery is excellent in long-term cycle life and cycle charge/discharge characteristics at ordinary temperature (for example, 30° C.). The battery of the present invention can be used as a stationary battery for load leveling.

1. A positive electrode having a surface of a positive electrode material covered with a solid polymer electrolyte,
wherein the solid polymer electrolyte comprises:
(i) a polymer having an ethylene oxide structure (—CH₂CH₂O—), and
(ii) an electrolyte salt compound which is a combination of lithium bis(oxalate)borate with another lithium salt compound,
one or both of the solid polymer electrolyte and the positive electrode material comprise:
(iii) a phenol compound having a phenolic structure in which both of two ortho-positions are substituted with a tert-butyl group.

2. The positive electrode according to claim 1, wherein the polymer (i) is a polyether copolymer comprising:
95-5 mol % of repeating units derived from a monomer of the formula (1): 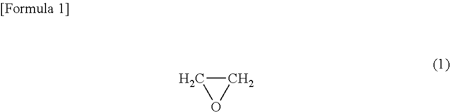
5-95 mol % of repeating units derived from a monomer of the formula (2): 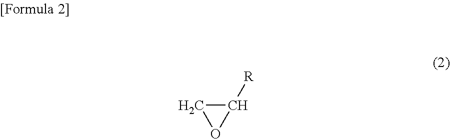
wherein R is an alkyl group having 1 to 12 carbon atoms, or —CH₂O(CR¹R²R³) where R¹, R² and R³ are a hydrogen atom or —CH₂O(CH₂CH₂O)ₙR⁴ in which n and R⁴ may be different among R¹, R² and R³, and R⁴ is an alkyl group having 1 to 12 carbon atoms or an aryl group optionally having a substituent group, and n is an integer of 0 to 12, and
0 to 20 mol % of repeating units derived from a monomer of the formula (3): 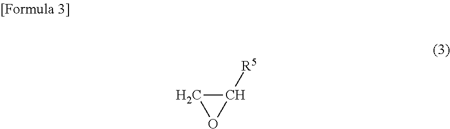
wherein R⁵ is a group containing an ethylenically unsaturated group.

3. The positive electrode according to claim 1, wherein the phenol compound (iii) is incorporated into one or both of the solid polymer electrolyte and the positive electrode material; by a method of coating, on the surface of the positive electrode material, a solution of the solid polymer electrolyte containing the phenol compound, or by a method of coating, on a metal electrode substrate, a slurry of the positive electrode material containing the phenol compound.

4. The positive electrode according to claim 1, wherein the phenol compound (iii) is a compound of the general formula:
A(X)₃
wherein A is a phenol group having tert-butyl groups positioned at two ortho-positions to OH group in the phenol group,
each of X is, the same or different, a hydrogen atom; a hydrocarbon group having 1 to 30 carbon atoms which may be interrupted by a sulfur atom, a nitrogen atom, an ester group, an amide group or a phosphate group is a group; or a group having the A group.

5. The positive electrode according to claim 1, wherein the phenol compound (iii) is at least one selected from the group consisting of 2,6-di-tert-butyl-phenol, 2,6-di-tert-butyl-4-methylphenol, 2,6-di-tert-butyl-4-ethylphenol, 1,6-hexanediol-bis[3-(3,5-di-tert-butyl-4-hydroxyphenyl) propionate], 2,4-bis-(n-octylthio)-6-(4-hydroxy-3,5-di-tert-butylanilino)-1,3,5-triazine, tetrakis[methylene-3-(3,5-di-tert-butyl-4-hydroxyphenyl) propionate]methane, 2,2-thio-diethylene bis[3-(3,5-di-tert-butyl-4-hydroxyphenyl) propionate], octadecyl-3-(3,5-di-tert-butyl-4-hydroxyphenyl) propionate, N,N′-hexamethylene bis(3,5-di-tert-butyl-4-hydroxy-hydrocinnamamide), 3,5-di-tert-butyl-4-hydroxybenzyl phosphonate-diethyl ester, 1,3,5-trimethyl-2,4,6-tris(3,5-di-tert-butyl-4-hydroxybenzyl)benzene, tris(3,5-di-tert-butyl-4-hydroxybenzyl) isocyanurate, and isooctyl-3-(3,5-di-tert-butyl-4-hydroxyphenyl) propionate.

6. The positive electrode according to claim 1, wherein an aprotic organic solvent is further added to the solid polymer electrolyte.

7. The positive electrode according to claim 6, wherein the aprotic organic solvent is selected from the group consisting of ethers and esters.

8. The positive electrode according to claim 1, wherein the positive electrode is heat-treated before an electrical potential is applied.

9. The positive electrode according to claim 8, wherein the heat treatment is conducted within the range of at least 50° C. and at most 150° C.

10. The positive electrode according to claim 1, wherein the positive electrode material has any of compositions of:
AMO₂
wherein A is an alkali metal, and
M is one or at least two transition metals which may partially contain a non-transition metal,
AM₂O₄
wherein A is an alkali metal, and
M is one or at least two transition metals which may partially contain a non-transition metal,
A₂MO₃
wherein A is an alkali metal, and
M is one or at least two transition metals which may partially contain a non-transition metal, and
AMBO₄
wherein A is an alkali metal,
B is P, Si or a mixture thereof,
M is one or at least two transition metals which may partially contain a non-transition metal.

11. A non-aqueous electrolyte secondary battery comprising the positive electrode according to claim 1.

12. A method of producing the positive electrode according to claim 1, wherein the method comprises the step of incorporating the phenol compound (iii) into one or both of the solid polymer electrolyte and the positive electrode material;
by applying, onto a surface of the positive electrode material, a solution of the solid polymer electrolyte containing the phenol compound, or
by applying, onto a metal electrode substrate, a slurry of the positive electrode material containing the phenol compound.
